(19) United States
(12) Patent Application Publication
(10) Pub. No.: US 2007/0168153 A1
(43) Pub. Date: Jul. 19, 2007

(54) METHOD AND APPARATUS FOR PHOTOGRAPHIC MEASUREMENT

(75) Inventors: Paul Minor, Granada Hills, CA (US); Laurent Ramis, Tarzana, CA (US)

Correspondence Address: KLEINBERG & LERNER, LLP, 2049 CENTURY PARK EAST, SUITE 1080, LOS ANGELES, CA, 90067, US

(73) Assignee: DIGICONTRACTOR CORPORATION, Granada Hills, CA (US)

(21) Appl. No.: 11/623,564

(22) Filed: Jan. 16, 2007

Related U.S. Application Data
(63) Continuation-in-part of application No. 60/759,140, filed on Jan. 13, 2006.

(51) Int. Cl. G06F 19/00; G01B 21/02

(52) U.S. Cl. 702/158

(57) ABSTRACT

Photographic and software technology are employed to derive accurate measurements of objects, areas or locations without requiring actual presence or physical measurement of the objects. Using a digital photograph and a scaling instrument disposed within the digital photograph (or other reference means), the measurements of various objects within a photograph can be derived quickly, easily and inexpensively utilizing computer software.

### CROSS REFERENCE TO RELATED APPLICATIONS

Priority is claimed as a continuation-in-part and reference is made to the co-pending provisional patent application entitled Construction Project Estimating System, Ser. No. 60/759,140 filed Jan. 13, 2006 owned by the assignee of the present invention. This provisional application is hereby incorporated in its entirety by reference.

### BACKGROUND OF THE INVENTION

1. Field of the Invention

This invention relates to the fields of measurement and photography, and, more particularly, to the use of digital photographs in conjunction withscaling instruments, and computer software to extrapolate the dimensions and other parameters or characteristics of an element within the digital photographs. The method and apparatus has applicability to construction projects, clothing measurements, interior design, remote surgery and other situations in which accurate measures are needed but access is difficult, costly or inconvenient.

2. Description of the Related Art

Existing methods and apparatus for measuring various objects exist and are well known in the art. The ruler or tape measure, for example, have been used for thousands of years. Various methods of digital photography are also well-known in the art. Until now, methods and apparatus for appropriately using these technologies in concert to measure objects have not been realized.

In the prior art, individuals must actually be present with the objects they wish to measure. To effectively use a ruler, an individual must be next to the object, place the ruler next to the object and thereby take measurements. The use of a tape measure or other similar measuring device requires similar presence.

In many cases, actual presence at a site or near an object is inconvenient. In some cases, presence at a site or near an object is dangerous or unhealthy. In other cases, presence is simply expensive.

Prior art methods have been devised whereby an individual may take measurements from a remote location. The costs to measure large distances, for example, using satellite imagery are high. Alternatively, other methods and apparatus have been devised whereby other individuals are hired to visit the site and to provide measurements. These methods and apparatus are not always trustworthy or accurate.

In the example of a construction site, accurate measurements are required in order to provide an accurate estimate of the costs associated with construction or renovation. Therefore, the consumer has been left in the position of having to pay for a construction worker or estimator to come to the site and gather measurements in person.

In yet other examples, including the measurement of an individual or the size of a piece of art from a remote location, have required visitation of the site. However, the present invention provides that a user need not be actually present at a location or with an individual.

As the costs, danger or inconvenience of taking accurate measurements outweigh the value to an individual, other method and apparatus may be devised to solve the problem of measuring objects while being in close proximity to those objects.

### SUMMARY OF THE INVENTION

The present invention integrates modern photographic and computer technology to provide a method of measuring an object, area or location using a scaling means as part of a digitally photographed image. Alternative means provide for the use of no scaling measure, but camera apparatus specifically designed to gather measurements used in conjunction with software designed to extrapolate those measurements automatically. Specifically, this method and apparatus uses digital photographic images of locations or objects to be measured in connection with software apparatus that may be used to extrapolate the measurements of the object, area or location depicted.

The present invention requires several steps in order to measure an object, area or location. Additionally, several alternative methods may be applied to thereby gather the measurement data for an object, area or location.

The first step of the preferred embodiment involves the use of a digital camera and a scaling instrument, configured as a measuring standard, to determine the exact dimensions of the area photographed. The area to be photographed must be two dimensional, as are most structural walls or land plots, and the photograph is preferably taken perpendicular to the object to ensure an accurate measurement using the scaling instrument.

Examples of a scaling instrument may include a marker with predetermined measurements, an image to be projected on the wall at a set distance, or even a tape measure placed against the structure. These scaling instruments may be used individually or in combination or unison.

In a second step of the preferred embodiment, a user inputs the digital photograph files into a software program which reads the scaling means in each photo and extrapolates the dimensions of the objects to make a three-dimensional model of the overall project. The digital photograph files may then provided to a computer aided design (CAD) software program to thereby determine the measurements of the relevant object, area or location.

Upon completion of the processing of the digital photographs, the computer program generates an output of the depiction of the object, area or location. The measurements of the object, area or location are accurate and easy to determine and read. The user my request measurements of specific objects or portions of objects. Software is provided whereby a user may see the photograph and the associated measurements, making measurements of his or her own as well.

In alternative embodiments, the use of a scaling instrument may be unnecessary. Recent technological advances provide for the use of stereoscopic cameras in addition to acoustic, radar and sonar techniques using cameras whereby a camera may “know” the distance from the camera to an object being photographed. Such a system enables a later viewer of the image to extrapolate measurements using trigonometry.

In yet another alternative embodiment, special scaling means (visible to the human eye or not) are utilized to project reference points on the wall. These scaling means may be images projected on a wall, invisible laser light, waves of sound or physical scaling means, as are described above. These scaling means, if projected, may be a built-in part of the camera or may, alternatively, be projected by stand-alone means.

In this alternative embodiment, software on the camera (or in the later computer aided design software) is capable of calculating the distance between two points, even at an angle, based upon the relative distance between the reference points that appear projected on a wall. These distances are used to determine the distance and angle at which a photograph is taken, then to extrapolate from that, using trigonometry, the measurements of objects or elements within the digital photograph.

It is therefore an object of the present invention to provide means by which measurements of various objects, ranging from exteriors of homes to cells and other microscopic bodies may be measured without requiring actual presence of an individual measuring the object. It is a further object of the present invention to provide software with which a user may review photographs later and measure alternative portions of the photo. It is yet another object of the present invention to provide safe, economical and convenient ways in which individuals may gather measurements of objects, locations or areas. These and other objectives of the present invention may be seen in the following detailed description of the invention.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is an image of a scaling instrument.

FIG. 2 is a depiction of the apparatus of the present invention.

FIG. 3 is a a flow chart showing the steps of the method of the present invention.

FIG. 4 is a screen capture of a page of software program useful in carrying out the present invention.

FIG. 5 is a screen in the software of the invention in which a photograph has been loaded for measurement.

FIG. 6 shows screen capture of the use of the software to point out the measurement means within the photograph.

FIG. 7 is a screen capture showing size selection of the measurement means.

FIG. 8 is a screen capture of the selection of the measurement functionality of the software.

FIG. 9 is a block diagram of an apparatus for gathering measurement data according to an alternative embodiment of the invention.

FIG. 10 is a block diagram of apparatus for gathering measurement data according to another alternative embodiment of the invention.

FIG. 11 is a block diagram of apparatus for gathering measurement data according to yet another alternative embodiment of the invention.

FIG. 12 is a block diagram of apparatus for gathering measurement data according to still another alternative embodiment of the invention.

### DETAILED DESCRIPTION OF THE INVENTION

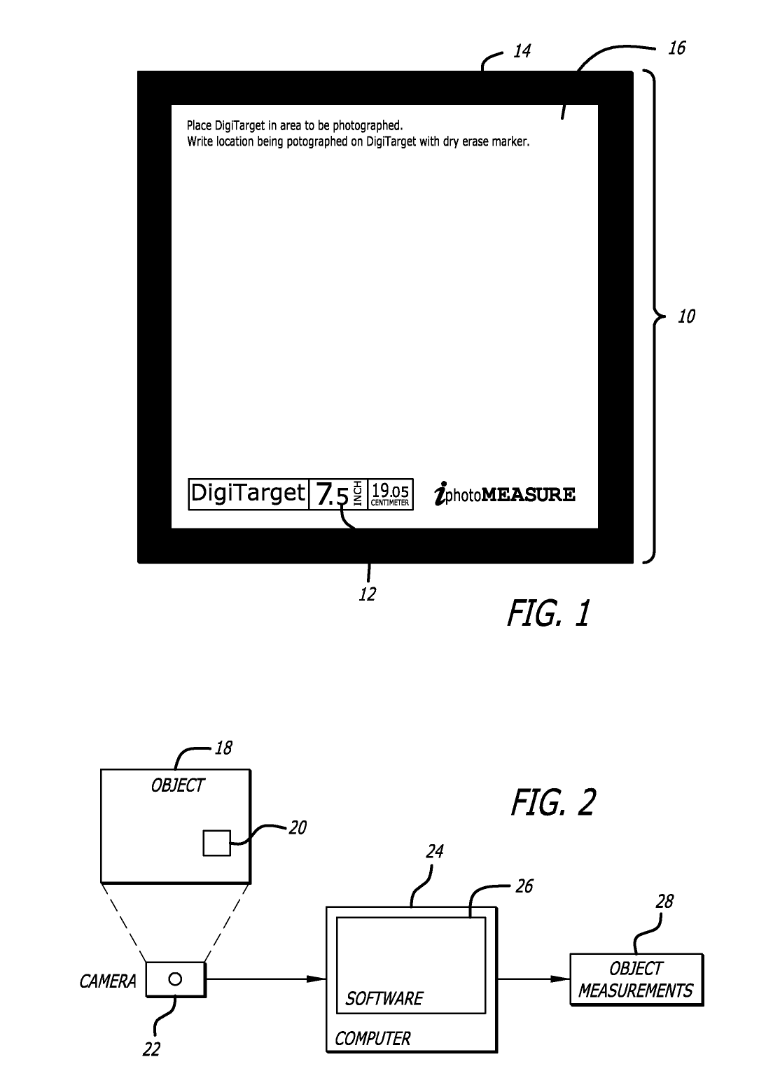

Turning first to FIG. 1, a scaling instrument (or scaling reference or marker), used as a basis to extrapolate the dimensions of an object, is shown in a slightly reduced scale. Scaling instruments, which are recognized by the computer software, are used to determine the overall dimensions of the picture in which the measurements are to take place. In the preferred embodiment, in order for the scaling instruments to work effectively with the computer software, they should be located on the same, two-dimensional plane, with the camera image plane parallel to that two-dimensional plane. That is, the axis of the lens is perpendicular to the plane of the image. In alternative embodiments, described with reference to FIGS. 13 and 14, the camera optical axis need not be perpendicular to the two-dimensional plane.

In the preferred embodiment, the scaling instrument is a square 10. The square 10 is designed in such a way that it is precisely sized with a predetermined height and width. In the preferred embodiment, the predetermined height and width are both 7.5 inches. This size can be seen in the label 12. It is to be understood that any size of scaling instrument may be used.

The square 10 is intentionally made up of a dark portion 14 surrounding a light portion 16. This is done to provide sufficient contrast in the subsequent photograph. The contrast is used to select the area of the scaling instrument to thereby determine a basis upon which to extrapolate additional measurements within the photograph.

As described above, the scaling instrument may be of any size. For example, a scaling instrument of very, very tiny size may be used to measure microscopic or other very small objects. A scaling instrument of very large size may be used to measure land areas on earth, using photographs taken from the air or satellite.

It is further to be understood that the scaling instrument depicted in FIG. 1 may be of any shape. The preferred embodiment of a square 10 is used only for purposes of example. Various shapes of any number of types may be used. It is also to be understood that high contrast is not necessary, but is used in the preferred embodiment.

The scaling instruments, such as the one depicted in FIG. 1, may also be created using a luminescent or photo-reactive spray in conjunction with a stencil. In this embodiment, the user applies the spray to the wall, using a stencil with pre-determined measurements. The spray is invisible to the naked eye. However, the camera is equipped with an activating light or is otherwise capable of making the spray visible to the camera for the short period of time necessary to take a picture suitable for gathering measurements. In this embodiment, the spray may be of a type that subsequently evaporates.

In alternative embodiments, marks may include projections of images which resemble the scaling instrument of FIG. 1. Alternatively, scaling instruments may not be used and instead stereoscopic photography may be used. In this embodiment of the invention, a camera that utilizes more than a single lens, such as a stereoscopic camera is used to capture photographs. These cameras, by virtue of having two points of comparison, are able to use trigonometry to derive the distance the camera is from a surface or target area. This distance can be extrapolated, using trigonometry, to determine the measurements of any object in the digital image. This embodiment is described more fully with reference to FIGS. 13 and 14.

In yet another alternative embodiment, acoustic, radar or sonar-equipped cameras may be used. These cameras may be used to send small beams of light, rapid sound waves or other known-travel-time indicators toward the wall being photographed. These sounds may or may not be audible to the human ear. The camera measures the time it takes for the projected beam or sound wave to return. This value may then be used to determine the distance to the wall from the camera. Once this value is known, as in the above alternative embodiment, the camera may extrapolate, using trigonometry, the measurements of any object in the digital picture being taken. This embodiment is described with reference to FIGS. 13 and 14.

In yet another alternative embodiment, a scaling instrument may be utilized at an angle. In the preferred embodiment, a user must have the focal plane of the camera perpendicular to the wall or objects that are being measured. In this alternative embodiment a user need not have the focal plane of the camera perpendicular to the wall (or other object being measured). The camera itself (or the CAD software) is equipped with means sufficient for performing calculations, based upon the distance between a series of points, projected or placed on a wall, relative to each other, such that the camera (or CAD software) is capable of using trigonometry to derive the angle at which a camera is set, relative to the wall, and thereafter extrapolating, using trigonometry, the measurements of any and all relevant objects or elements within a room. This embodiment is described with reference to FIG. 14.

FIG. 2 is a block diagram of the apparatus of the present invention. The first element used in measuring an object, is the object 18 itself. The present invention need not require the presence of the individual conducting the measurements.

Measurement means 20, referred to earlier as the scaling instrument, is provided within the frame of reference of the object 18. The measurement means 20 may take many forms. In the preferred embodiment, the measurement means 20 is a scaling instrument such as the square 10 (described with reference to FIG. 1). In alternative embodiments, the measurement means 20 is a projected or spray-on scaling instrument. In yet other alternative embodiments, the measurement means 20 may be sonar or laser detection of the distance from the camera to the wall. Various measurement means 20 are described more specifically below.

A camera 22 is, preferably, a digital photography camera of a very high resolution capability. The resolution of modern digital cameras is continually being increased. Currently, high resolution cameras easily available to consumers are capable of resolutions greater than 6.0 mega pixels. However, it is anticipated that the resolution of cameras will increase substantially over time. The present invention envisions this increase and is designed in such a way as to take those increases into account.

The camera 22 is used to take a photograph of the object 18 with the measurement means 20 within the photograph (or otherwise recorded, as described below). In alternative embodiments, a non-digital camera may be used and the photograph may be subsequently developed and scanned into a digital file by means of a high resolution scanner. This typically results in a degraded quality of measurement and is not preferred. However, the method of this invention may be practiced utilizing this form.

The photograph created by the camera 22 is then uploaded, copied or otherwise transferred to a computer 24. The computer 24 includes software 26 for use in extrapolating the measurements of the object 18 within the photograph. In the preferred embodiment, several photographs may be taken so as to provide a cross-check as to the accuracy of the measurements.

The software 26 is then used to extrapolate the object measurements 28 on the basis of the measurement means 20 provided as a frame of reference for the object in the photograph. These object measurements may be used for any number of purposes, including creating a three dimensional rendering of a location or object or requesting an estimate as to costs to alter or remodel a property, room or home. Additionally, these measurements may be used to properly size individuals or to simply gather data pertaining to an area, such as acreage or square footage of a farm or other locations.

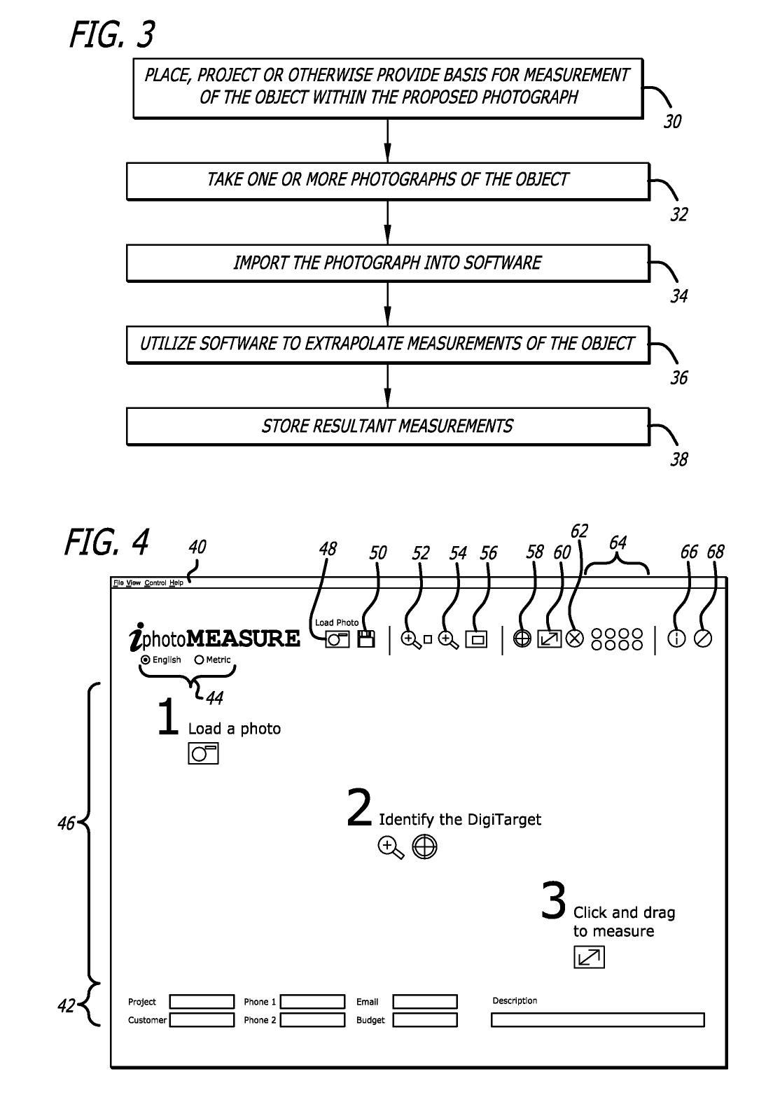

FIG. 3 is a flowchart of the preferred embodiment of the present invention. It is to be understood that additional or fewer steps may be taken while still maintaining the overall scope and spirit of the present invention.

A first step 30 is to provide measurement means 20 within a photograph of the object 18. This step requires the placement of the scaling instrument or measurement means 20 within the scene of the photograph that will be taken. In the preferred embodiment, the use of a scaling instrument 20 will satisfy this step. In alternative embodiments, the recording of distance data (or extrapolated measurement data pertaining to one or more objects) may be used as the basis for measurement of the object 18.

A next step 32 is to take one or more photographs of the object 18. Each photograph should include the measurement means 20 (or multiple measurement means 20). A next step 34 is to import the photograph into software 26. In this step, the photograph, including the measurement means 20, is imported into the software 26. The process of importing the photograph may take many forms, from the emailing or downloading of images from a digital camera to developing a set of photos on a conventional camera and scanning those photos into a digital form. It is to be understood that this step is used to accomplish the task of providing the photographs to software 26 for subsequent measurement.

A next step 36 is to utilize the software 26 to extrapolate measurements of the object 18. The software 26 of the preferred embodiment, depicted in FIGS. 4-8, may be used to gather data about the scaling instrument and then extrapolate this data to other objects, such as the object 18 being measured, in the photograph. It is to be understood that the software 26 depicted in FIGS. 4-8 is depicted for purposes of example and that any number of graphical and non-graphical software providing the functionality of the present invention may be used.

A final step 38 stores the resultant measurements in one or more forms. The measurements may be stored, graphically, upon the image itself, so that subsequent viewers of the image may determine measurements of various elements within the picture. Additionally, data may also be stored in a data file format, including references such that a view of a photograph and related data file may determine which elements correspond to which measurements.

It is further to be understood that the software 26 may measure and extrapolate based upon user interaction or, alternatively, automatically. Any automation may also be in various degrees. Software of a particular type is capable of optical character (or marker) recognition (OCR or OMR). Software of this type is capable of automatically recognizing the scaling instrument and thereby extrapolating measurements for various elements within the photograph.

More advanced software still may create complete three dimensional renderings from the extrapolation and positioning of a group of photos. Less advanced software may automatically recognize the scaling instrument, but require user input as to which objects within a photograph are to be measured. It is to be understood that each of these software embodiments of this method are included within the method of this invention.

FIG. 4 is a screen capture of the program of the present invention in operation of the preferred software embodiment of the method of this invention. It is to be understood that numerous other embodiments may be used, still utilizing the method of this invention.

A menu bar 40 provides a series of drop-down menus regarding various functionality of the software 26. Methodologies of menu bars are well-known in the art. The preferred method of carrying out the functionality of the present invention is to utilize the large buttons disposed at the top of the graphical user interface of the software 26.

The display includes a series of boxes 42, such as a project box, for use in saving information relating to the reason for taking measurements of the photographed object. The software 26 also includes radio buttons 44 for choosing between “English” and “Metric” units for measurement purposes. These radio buttons 44 cause measurements to be taken in either unit-type as desired by a user.

The next element is the simplified software instructions provided within the large display area 46 of the software 26. Images of the buttons required to activate particular steps, including a first button 48, the “load photo” button. As can be seen, the text describing the functionality of a button is highlighted as a user places a cursor over the button. This button is used to activate the first step 46 of using the software, and, as can been seen in the graphical depiction of step one, in element 46.

A next button 50 is the “save” button. The save button is used once an individual has measured an object within a photograph to thereby save a copy of that image with the measurement overlaid upon the photo. These photos, including measurements, may then be provided to others for various uses, including review of the measurements, the creation of a construction estimate, gathering measurements of an individual or measuring very small objects.

A next button 52 is the “zoom in” button. This button 52 is used, once the photograph is loaded, to move the visual display of the user closer to the photograph. Being closer to the photograph allows a user to make more accurate measurements. The “zoom out” button 54 moves the visual display of the user further from the photograph in order to view a larger area of the photograph.

A next button 56 is the “pan” button, which by clicking on it and then in a portion of a photograph, “grabs” the photograph and a user may thereby move the visual display of the photograph around on the screen. A “digitarget™” button 58 is used, as will be seen in subsequent figures, to select the area of the scaling instrument. The “measure” button 60 is used to create a line on screen beginning from the first place a user clicks to the next place a user clicks and creates a visual display of the measurement of that line within the photograph.

A next element 64, is a series of color selectors. These may be used to select various colors for the lines depicted in the measurement visualization. These lines will be seen in subsequent figures. A next element is a “help” button 66 which a user may click to be presented with a series of help dialogs to thereby determine how to use the software or to address any issue the user may be presented with.

Finally, a “quit” button 68 is depicted. A user may select this quit button 68 once the software need no longer be used to measure an object. This button closes the software application and ends the user measurement session.

FIGS. 4-8 illustrate the software of the preferred embodiment in use. FIGS. 4-8 are used to elaborate on the preferred method of the present invention, but are to be understood to be purely representative of the overall concept and method of this invention. It is to be understood that more complex and more simple software and hardware embodying the present invention may be created. The software depicted in FIGS. 4-8 is only provided as an example of the preferred embodiment of the invention.

Referring still to FIG. 4, an example of the process of present invention is shown. In the first instance, a user selects the load photo button 48. A user is thereby presented with a dialogue box requesting input as to the location of a photograph for use in measuring an object. This photograph, in the preferred embodiment, includes a scaling instrument or other marker. A user utilizes methods well known in the art to select a photo from any number of locations.

A user may, at this point, select the proper units of measurement, English or Metric, using radio buttons 44. A user may also input relevant data into the boxes (or similar elements) represented in element 42 pertaining to the measurements to be made. If necessary, a user may request help using the help button 66 or exit the application using the quit button 68.

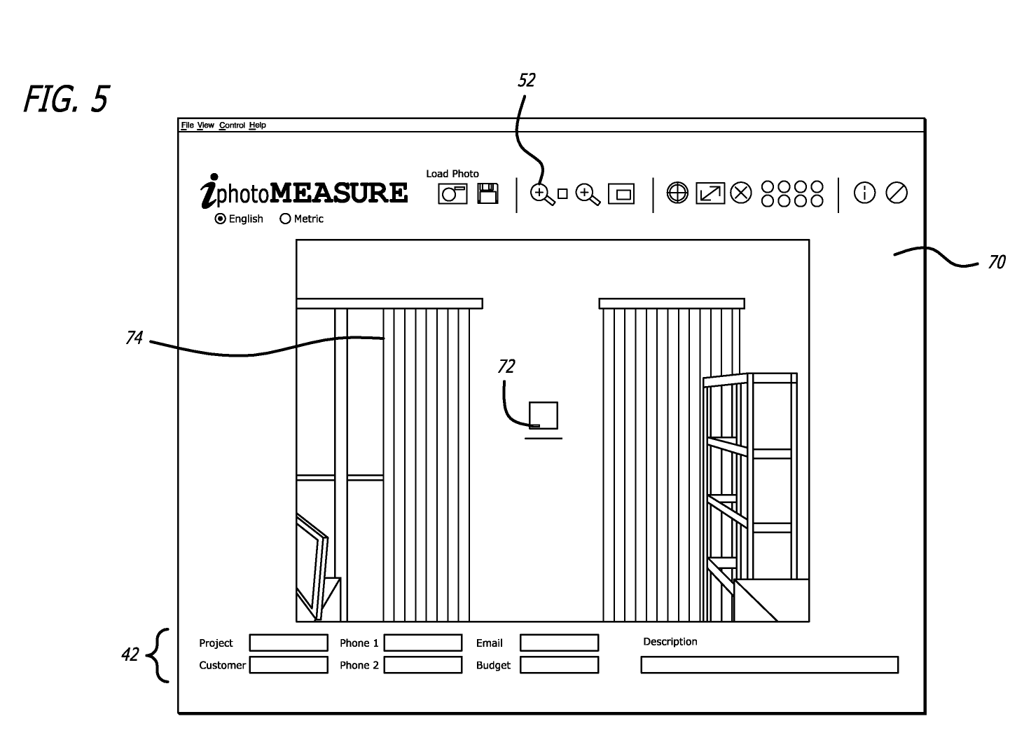

Referring now to FIG. 5, a photograph 70 has been loaded into the software. The photograph 70 is displayed, including the scaling instrument 72 as depicted in FIG. 1. The project number in element 42 has been automatically entered using the file name of the photograph 70. In alternative embodiments, a project name may be requested or otherwise automatically generated or may not be provided at all.

The zoom in button 52 has been selected, as can be seen from the highlighting small circle in the upper left hand corner of the zoom in button 52. The cursor 74 of the software takes on a cross-hair visual including a circle containing a plus in the upper right corner of the cursor 74. This is well-known in the art to represent “zoom in” functionality as selected.

A user may then highlight an area of the photograph, using the cursor 74 to thereby “zoom in” the picture to that portion of the photograph 70. Alternatively, a user may simply click in an area of the photograph 70 to thereby “zoom in” to that area.

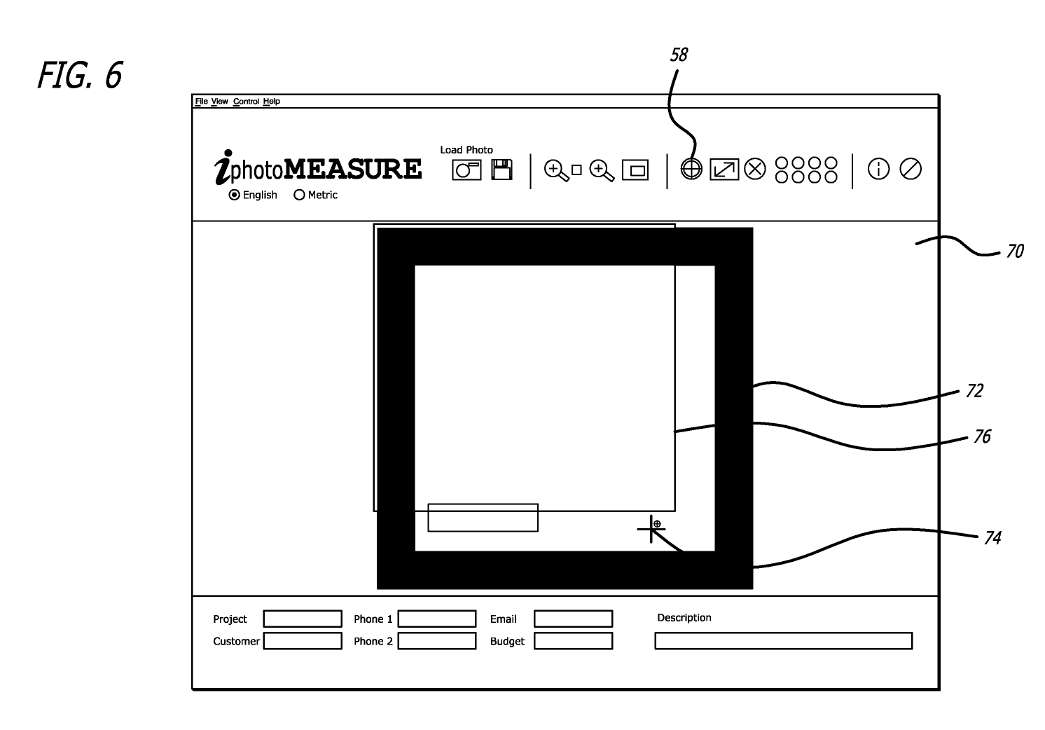

Referring next to FIG. 6, a zoomed in portion of the photograph 70 is shown. The scaling instrument 72 is depicted centrally in the photograph 70. A user likely will desire to zoom into the picture in such a manner initially so as to provide the most accurate indication of the area covered by the scaling instrument 72.

As can be seen, the digitarget™ button 58 is depressed. A user of the software of the preferred embodiment must utilize the digitarget™ button 58 to activate the cursor such that it is capable of highlighting the area covered by the scaling instrument 72.

The process of highlighting the scaling instrument 72 can also be seen in this figure. After a user activates the digitarget™ button 58 (as can be seen from the highlighting small circle in the upper right hand corner of the button) the cursor 74 becomes a cross-hair including an additional small cross-hair in the upper right corner. This signifies that a user may now use the cursor to delineate the area of the scaling instrument 72 within the photograph 70.

It may be understood why a user of the software may wish to zoom in on the photograph 70, so as to provide a close up view of the scaling instrument 72 within the photograph. A user may then use the cursor 74 to highlight the area of the scaling instrument 72. The scaling instrument selection area 76 is created by clicking and dragging the cursor from one corner of the scaling instrument 72, as depicted in the photograph, to the other corner of the scaling instrument 72 and then releasing the mouse click.

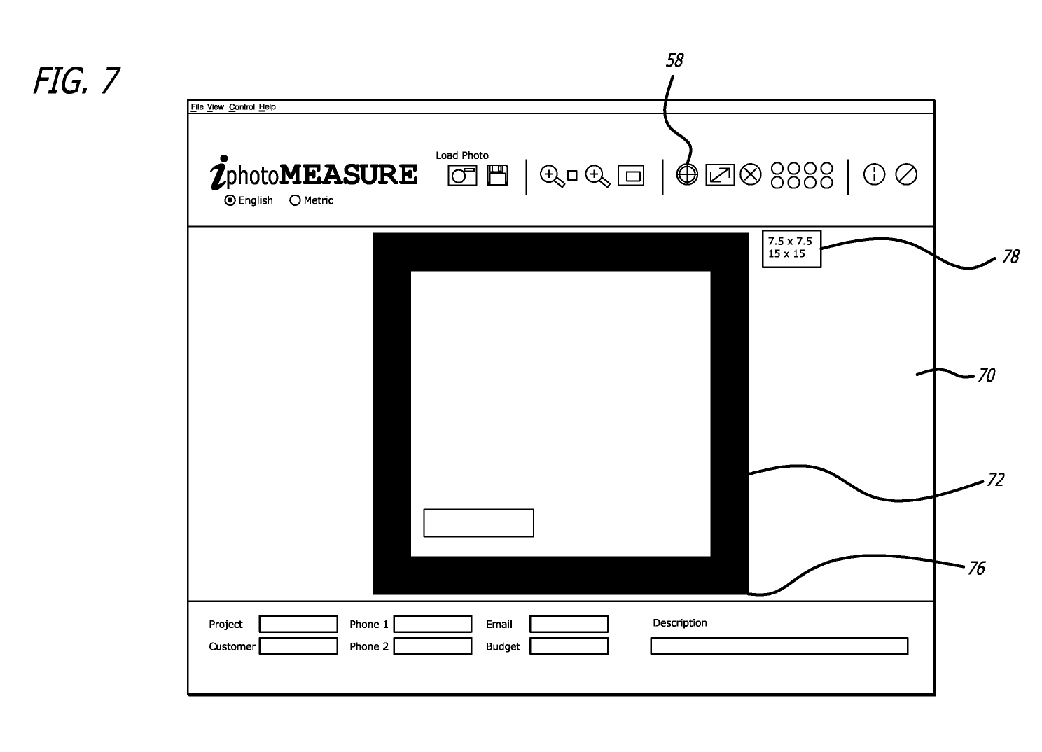

Referring next to FIG. 7, the scaling instrument selection area 76 is shown. With the digitarget™ button 58 is still selected. The photograph 70 now has the scaling instrument 72 highlighted (as can be seen by the darkened dots surrounding the corner of the scaling instrument 72). The area between these dots is the now-complete scaling instrument selection area 76.

Also shown is the scaling instrument selection dialogue 78. This dialogue 78 is used to select the size of the scaling instrument 72. In the preferred embodiment only two scaling instrument 72 sizes are available. In alternative embodiments, there may be a multiplicity of scaling instrument 72 sizes. In yet other alternative embodiments, a user may be able to input the size of the scaling instrument 72 by hand. This embodiment allows users to utilize non-standard scaling instruments, such as reference objects within the photograph 70.

After using the scaling instrument selection area 76 and the scaling instrument selection dialogue 78, the zoom out button 54 becomes highlighted. This indicates that the user may now “zoom out” on the picture in order to begin measurements. The photograph 70 and scaling instrument 72 have now been selected, as can be seen by the scaling instrument selection area 76. The user may now, if desired, move the visual display further from the photograph using the zoom out button 54 to thereby begin the process of measuring objects within the photograph.

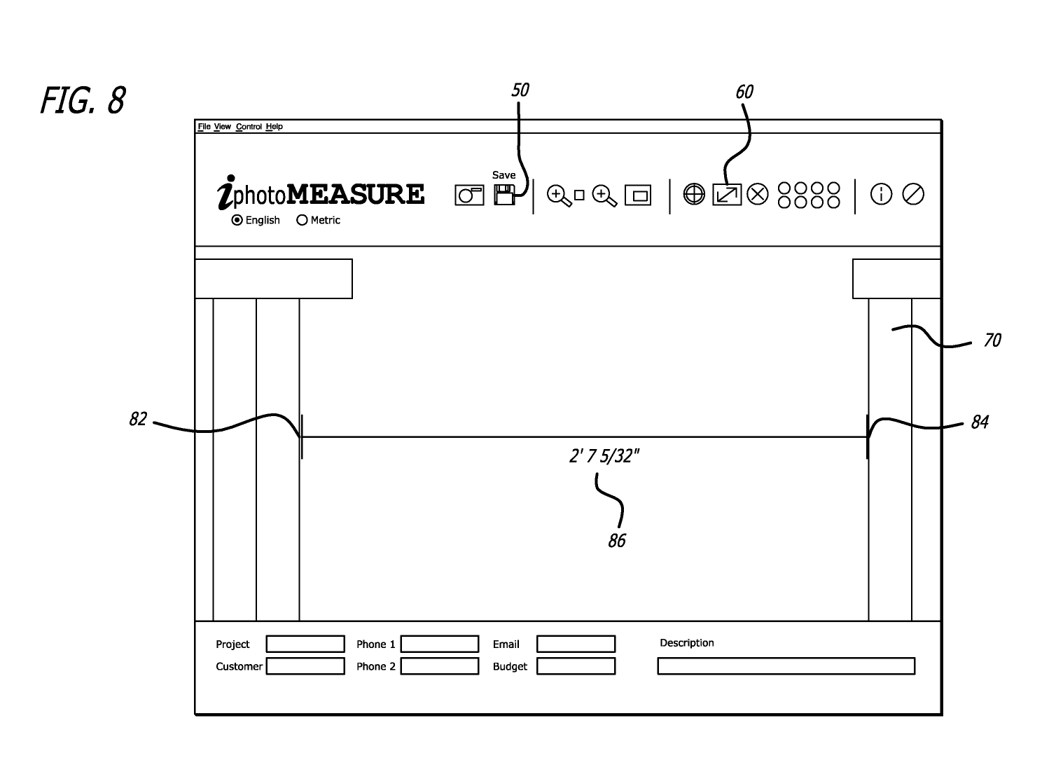

Referring next to FIG. 8, a zoomed out photograph 70 demonstrating the process of measurement is shown. The scaling instrument 72 has been set and may now be used to measure objects in the picture. The measure button 60 is highlighted. A user may select the measure button 60 to thereby begin the process of measuring elements within the photograph after the scaling instrument selection area 76 has been set.

When a user selects the measure button 60, the cursor becomes a cross-hair with a small depiction of the measure button 60 icon in the upper right corner. The user may then use the cross-hair to click in the location of one side of an object within the photograph that a user wishes to measure. The location of the first click in this example is shown in element 78.

The first click location 82 sets a basis from which the measurement is made. The user may then move the mouse to any location in the photograph to measure the distance between the first click location 82 and the second click location 84. As the user moves the mouse, a measurement 86 in numerals appears beneath (or beside) the resulting line between the first click location 82 and the current cursor position.

FIG. 8 shows the line created once a user has set a first click location 82 and subsequently clicked in the second click location 84. A user may subsequently create any number of measurements 86 within the same photograph to thereby create accurate measurements of objects appearing in the photograph.

The user may then select the save button 50 to save the images, including the first click location 82, the second click location 84 and the measurement 86 within the photograph. In the preferred embodiment, the save file is an image file, saved under a different name, such that the measurements may be seen quickly by referring to the new saved image file including the photograph 70.

In alternative embodiments, the saved file may be or include a textual indication of the various measurements or an extensive markup language file containing measurements and a reference to the relevant image file. Alternatively, a file or series of files may be created in such a format as to be readily acceptable by a computer aided design or other similar program that is capable of creating rendered drawings of an object, based upon the measurements provided.

The preferred embodiment of the present invention works through employing a method of mathematical extrapolation utilizing the properties of digitally-stored photographs. It is well-known in the art that digital photographs are made up of a series of pixels. Pixels represent an arbitrary size in any photograph and are set, by digital photographic means to a single shade or color within a photograph.

A typical digital photograph is made up of thousands or millions of pixels. When a user of the method of this invention takes a photograph including the scaling instrument, the scaling instrument is represented by a series of pixels. Because in the preferred embodiment the scaling instrument is a square and a user of the preferred embodiment of this invention must be perpendicular to the object to be measured for accuracy (the user need not be in some alternative embodiments), the pixels representing the scaling instrument in the photograph make up a square.

The user (or in some embodiments, the software automatically), through highlighting the scaling instrument, thereby sets a basis upon which to create a scale comparison of pixels to inches within the software. That is, by delineating within the software that, for example, a 40 pixel by 40 pixel portion of the photograph is, in fact, a 7.5 inch by 7.5 inch square as determined by the scaling instrument, the size of the photographic area as a whole (and various elements within the photograph) may then be measured with considerable accuracy.

Modern digital photography, as described above, is capable of creating digital images of substantial clarity. Clarity in digital photography is defined by the number of pixels used to store the image taken by a digital camera. Excellent cameras today are capable of 8.0 to 12.0 mega pixels per image. Commonly available cameras are capable of 3.0 to 5.0 mega pixels.

As can be understood, the more pixels included within a digital photograph, the more accurate the resultant measurement of objects within the photograph will be. If a user creates a high-resolution photograph, the number of pixels will be high, the contrast between various elements within the photograph will be high as well.

When a user highlights the scaling instrument within the photograph, thereby selecting, for example a 40 by 40 pixel area, for a 7.5 inch by 7.5 inch scaling instrument, the conversion is then 7.5/40 or 0.1875 inches per pixel. This may be used as a fairly accurate measure. Alternatively, when a 400 by 400 pixel area, for a 7.5 inch by 7.5 inch scaling instrument is used, then the conversion is 7.5/400 or 0.01875 inches per pixel. This is a measurement scale of ten times the accuracy of the preceding scale.

As can be seen, the high pixel (high quality) digital photographs are desirable for creating very accurate measurements. However, a measurement only 0.1875 inches (less than a quarter inch) from perfect is still substantially accurate for most applications.

Additional photos may also act as confirmation of accurate measurement. The software may identify each photo independently and calculate measurements for each photograph independent of previous photographs. As the final stage, the compilation and construction of a three-dimensional model may be done. The multiplicity of photographs and measurements may be used to resolve any discrepancies between overlapping photographs and general deviations greater than a set maximum. Additionally, these discrepancies may be reported to a user of the software. This reporting system allows for the correction of discrepancies and acts as a failsafe for providing accurate measurement.

The resulting measurements or three dimensional representation of the object, location or area may be used for various means. In the example of a construction or renovation project, a contractor or series of contractors may provide estimates of the cost of the construction or renovation based upon the measurement estimates provided by this method and apparatus.

Alternatively, an individual may be able to extrapolate measurements of an individual person. A relative in a remote location could view photographs of an individual containing a scaling instrument and thereby create measurements sufficient to enable that relative to purchase correctly-sized clothing for that individual.

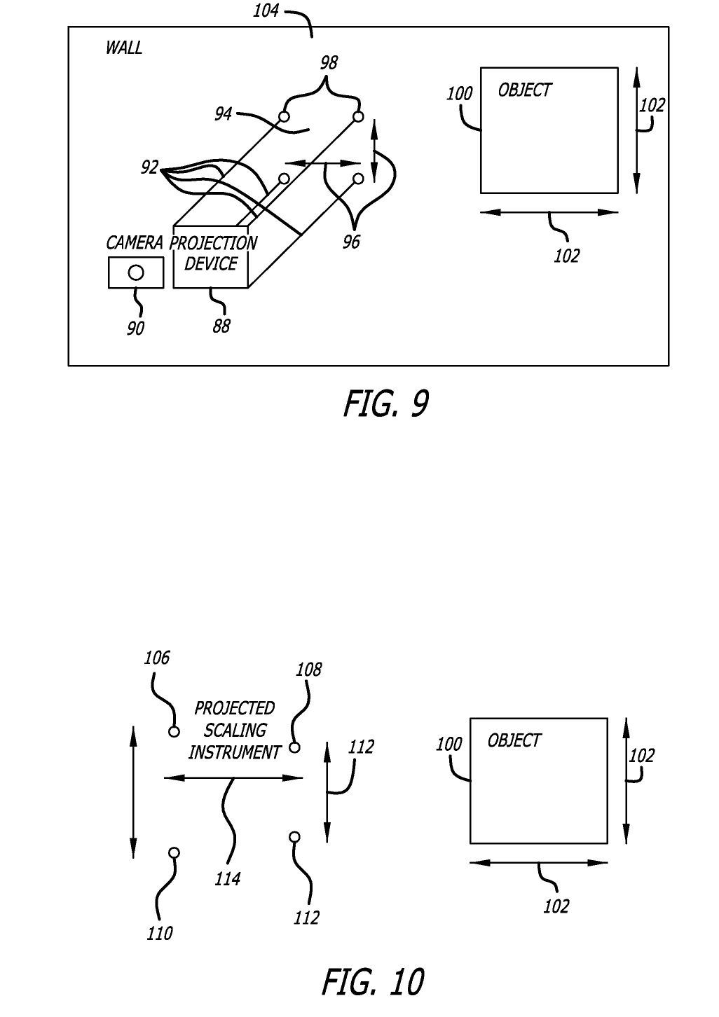

FIG. 9 shows an alternative to a portion of FIG. 2 utilizing a projection device 88 to project an image of a scaling instrument 94 which is used to provide the necessary dimensional information. A wall 104 is targeted by a projection device 88 placed at a fixed distance away from the wall 104. The projection device 88 projects a scaling instrument 94 image upon the wall 104. The projected scaling instrument 94 is used by software to extrapolate the dimensions of an object in the resulting photograph. Any projected scaling instrument image 94 which has known, predetermined dimensions may be the basis for measuring the object 100.

In this alternative embodiment, the projected scaling instrument 94 may be a series of laser-created dots 98. Near these dots 98 or within these dots 98 may be projections of the relevant data, such as the distance between dots 98. The laser beams 92 are created in such a way that their distance from each other is a known constant and may be projected as a portion of the image.

Alternative embodiments may encode data into the projected scaling instrument 94 or laser beams 92, invisible to the naked eye, but sufficient for a computer to read by reviewing pixels, regarding the distances at which the series of dots 98 are disposed relative to each other. This embodiment would enable software to be further integrated such that it may read this otherwise invisible data to thereby provide a basis for measuring objects in the photograph. The invisible data may be in the form of a bar-code, numerical data or other computer or user-readable data encoded within the photograph.

The lasers may also be created such that they are slightly off of center by a known degree. Thereafter, a computer that subsequently reviews the image, knowing the distance the lasers are designed to be apart and the slight angle at which the lasers are positioned, may thereby utilize trigonometry to derive the distance the lasers were positioned from the wall (or other object) and to thereby derive the measurements of the lasers projected on the wall (or other object). Thereafter, these base measurements may be used to extrapolate the measurements 102 of any object 100 in the frame of a photograph taken by a camera 90 insufficiently similar position as the laser beams 92 source.

Alternatively, the projected scaling instrument 94 may simply be an image corresponding to known scaling instruments created by means of regular or laser projection. A user would simply use the previously described means to thereby highlight the area of this projected scaling instrument 94 to provide a basis for measuring an object 100 in the photograph.

The projection device 88 is shown as an element separate from that of the camera 90. It is to be understood that the projection device 88 may be built into a special camera designed for the purpose of implementing the method and apparatus of this invention. As is shown, however, the projection device 88 is separate and distinct from the camera 90.

FIG. 10 shows an example of the projected scaling instrument 94 of FIG. 9. In this example, the projection device 88 (from FIG. 9) creates a series of dots 106, 108, 110, 112 in an 8 inch by 8 inch square (or other known area). However, the camera 90 is placed at such an angle so as to produce a projection such that the two top dots 106, 108, are, instead 9 inches apart, as are the two bottom dots 110, 112. The two left dots 106, 110 are 8 inches apart, whereas the two right dots 108, 112, are 6 inches apart.

To the naked eye, these dots 106, 108, 110, 112 are not particularly helpful in determining measurements, but computer software, which has information pertaining to the distance from the camera to the wall and pertaining to the measurements of the image as it is projected from the projection device 88, may use these dots in the subsequently-created picture to extrapolate measurements, even with the camera at an angle, for virtually any area depicted. As can be seen, the dots on the right 108, 112 are closer together, thereby demonstrating that the projector is closer and at an angle to the right, whereas the dots 106, 110 are further apart on the left. This demonstrates that there is additional distance for the dots to separate and that the camera is further from the left side than the right.

The software takes note of these values and the differences, in light of the distance from the camera to the wall and the known distance between the dots 106, 108, 110, 112 in the original projection and calculates relevant measurements 102 of an object 100. In alternative embodiments, subsequent computer aided design software may extrapolate these distances and measurements based only upon the uploaded images. This method overcomes the prior art in that it enables the measurement of objects in a photograph while at an angle from the point of reference.

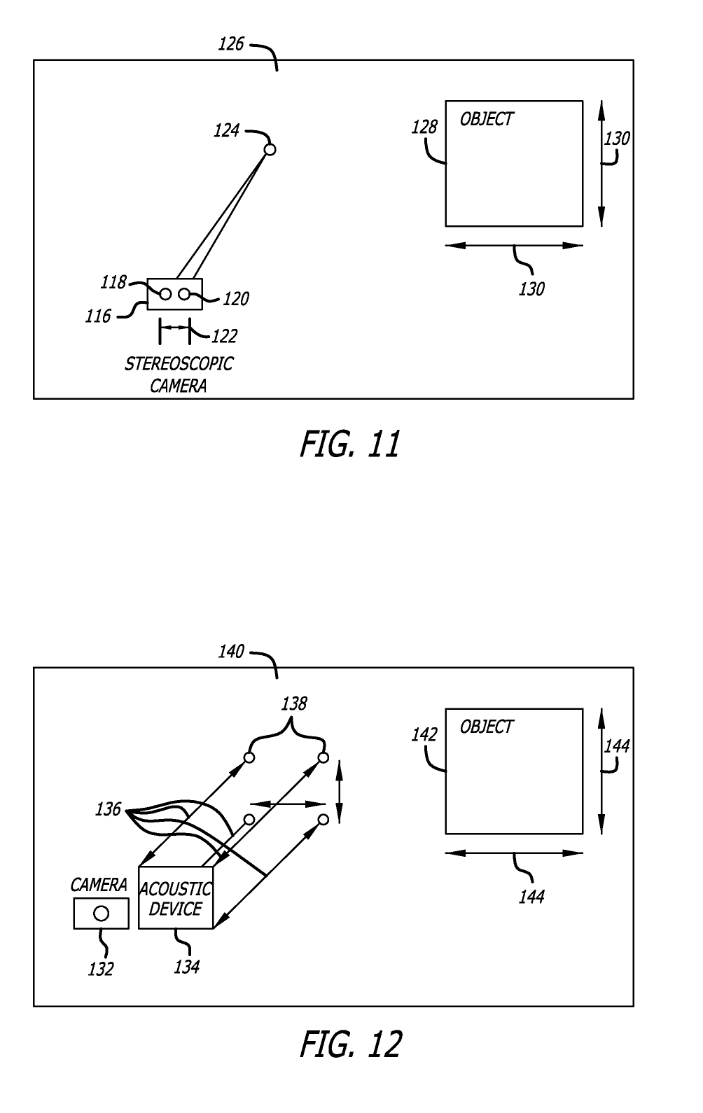

FIG. 11 is another alternative embodiment, utilizing a stereoscopic camera 116. The stereoscopic camera 116 may take many forms. These types of cameras (or related devices) can be used to gather measurements, such as the distance to the object being photographed. For example, in the embodiment utilizing a stereoscopic camera 116, a picture is taken utilizing at least two lenses 118, 120. These two lenses 118, 120 create two images of the same object 124.

Differences in the resultant two images, in conjunction with the known distance 122 between the two lenses and the, very small, angle from each of the two lenses 118, 120 to the object 120 may be used to extrapolate by trigonometry, with great accuracy, the distance from the point directly between the two lenses (or from a particular camera) to a point on the wall 126. The stereoscopic camera 116 may then extrapolate measurements of objects within the photographs based upon the distance to the wall 126.

Once the two images are taken using the distance 122 between the two lenses 118, 120, the measurements 130 of an object 128 appearing within both photographs may be calculated. This object 128 may be used similarly to the aforementioned scaling instrument 94 (see FIG. 9). From this scaling instrument 94, the measurements 130 of any other object 128 within the picture may be derived.

Additionally, once a baseline is established using the stereoscopic camera 116, software may be used to derive the measurements 130 of other objects in the image, including objects not in the same plane as the scaling instrument 94. Trigonometry, three dimensional rendering and three dimensional recognition software may be used to derive measurements 130 for virtually any object appearing in both images based upon the differences appearing in the pictures and the known distance between the two lenses taking the images.

This distance 122 between the lenses 118, 120, and the angles created by imaginary lines drawn from the lenses to various points on the wall may be used determine the distance from the camera to various points on the wall or in other locations within the picture. This distance may be used to derive additional measurements 130. This process may be iterated until accurate measures of all relevant objects are gathered.

Alternatively, this process may be conducted only once to thereby create an invisible scaling instrument 94 (as seen in FIG. 9) for use with the photos. In this embodiment, a scaling instrument 94 may be written directly onto the photograph, for later use, by the software. Alternatively, a separate data file may be created retaining the distance from the camera 116 to the wall 126 and the measurements 130 of an invisible scaling instrument 94.

In yet another alternative embodiment, two or more images may be created using a single camera. These images may be taken from two, known distances from each other (as is the case with the two separate lenses in a traditional stereoscopic camera). These two images may subsequently be compared utilizing the known distance between the two camera locations and the angles to the object being measured from both lenses to determine the distance to an object.

This embodiment provides all of the benefits of the stereoscopic camera without the added cost and specialized equipment required, such as a camera with two lenses, two sets of film (or digital photography hardware) and the like. This embodiment does require knowledge of the distances between the two cameras and angles, however, which are typically more easily measured or known in a stereoscopic camera wherein the lenses are arranged at set distances from each other and known angles may be more easily derived.

FIG. 12 shows an alternative embodiment utilizing an acoustic device 134 in connection with the camera 132. It is to be understood that the acoustic device 134 may be integrated into the camera 132 or may be provided, as shown, as a device separate from the camera 132 or attached to the camera 132.

FIG. 12 may also be understood to show other alternative embodiments wherein the camera 132 is used in conjunction with sonar or radar-based devices. Each of these alternative embodiments provide functionality virtually identical to the acoustic device.

In this embodiment, an acoustic device or sonar device emits at least two sounds 136 as the picture is taken. The acoustic device, knowing the speed of sound at a certain air pressure, records the amount of time it takes for each sound 136 to travel to the wall 140 or other object and back. This time is halved for each sound and the acoustic device 134 (or an associated computing device) uses trigonometry to thereby determine the distance to the wall 136 from the acoustic device 134.

In order to calculate the measurements of objects in the picture, the distance and the angle of the sound must be known. The distances between the sound emitting devices on the acoustic device 134 are known as are the angles at which the sounds are emitted. The time is calculated, independent for each sound emitting device on the acoustic device 134. Because the distances are calculated independently, the placement of the acoustic device 134 at an angle relative to the wall 140 or other object may also be discovered using this method.

In this alternative embodiment, the best form is to utilize an acoustic device 134 including four sound emitting devices and a single sound reception device. The sound emitting devices are situated in the four corners of the acoustic device 134. Each sound emitting device produces a distinct sound, such that they may be differentiated by a reception device from one another. Furthermore, the acoustic device 134 is a built-in portion of the camera 132. The angles of the sounds 136 emitted by the sound emitting devices are known and the distances between each sound emitting device on the acoustic device 134 are known.

The sounds 136 emitted by the acoustic device 134 hit the wall 140 in multiple locations 138 on the wall 140. The sounds 136 bounce back and, using the known angles at which the sounds 136 were emitted, the speed of sound at a particular pre-determined air pressure and the time taken for the sounds 136 to return; the distance to the wall and angle at which the acoustic device 134 is situated relative to the object hit may be calculated.

Using the angles and distances of the sound emitting devices disposed within the acoustic device 134, the measurements 144 of any object 142 within the picture may be calculated using trigonometry. This object may be used as a scaling instrument 94 (as seen in FIGS. 1 and 9) to thereby extrapolate measurements for other objects within the picture. Furthermore, because this methodology is capable of detecting angles at which the acoustic device 134 is situated relative to the wall 140 or object 142 being measured, it may be used while not perpendicular to the wall 140 or other object 142.

While four sound emitting devices are used in this example, two or more sound emitting devices disposed within the acoustic device 134 may be used. It is also be understood that the distances measured using this methodology may be recorded or otherwise stored in a separate data file suitable for use by three dimensional rendering software or other measurement software later, as is described in previous embodiments.

Thus there has been shown and described a method and apparatus for measuring objects, areas and locations using digital photography and software. The present invention utilizes a scaling means disposed within the digital photograph (or associated data) to thereby derive an appropriate standard by which objects may be measured in a digital image. Appropriate software can use these digital photographs to create models suitable for any number of uses including: construction estimates, gathering sizes for individual clothing, determining ring sizes, extrapolating the sizes of buildings, measuring large distances using aerial photographs or microscopic measurements, using very small scaling means.

The foregoing should not be considered a limitation on the scope of the invention. The invention should only be limited by the scope of the claims appended below.

What is claimed as new is:

1. A method for photographic measurement, comprising the steps of:
creating a digital photo image containing a scaling instrument; and
processing said digital photo image with computer software to extrapolate measurements of objects within said digital photo image containing said scaling instrument.

2. The method of claim 1 wherein said scaling instrument is an object of known dimensions within said digital photo image.

3. The method of claim 1 wherein said processing step includes the creation of a ratio of pixels to a known unit of measurement.

4. The method of claim 1 wherein said processing step includes at least the following steps:
analyzing said digital photo image to find said scaling instrument;
selecting the area of said digital photo image taken up by said scaling instrument;
setting the size of said scaling instrument in a known unit of measurement;
creating a ratio of pixels within said digital photo image to said known unit of measurement; and
utilizing said ratio to extrapolate the measurements of an object within said digital photo image.

5. The method of claim 1 wherein said scaling instrument is a projected image.

6. The method of claim 1 wherein said scaling instrument is made up of two or more laser beams of a known distance from each other and projected at a known angle.

7. The method of claim 6 wherein said laser beams project information pertaining to said known distance and said known angle on an object.

8. The method of claim 6, wherein said laser beams project information pertaining to their distance from an object.

9. A method for photographic measurement, comprising the steps of:
creating a digital photo image using a digital photo camera;
measuring the distance from said camera to an object;
determining the angle at which said digital photo camera is from said object; and
processing said digital photo image with computer software to extrapolate dimensions from said digital photo image using the distance from said camera to said target to thereby measure objects within said digital photo image.

10. The method of claim 9, wherein said measuring step utilizes an acoustic measurement device.

11. The method of claim 9, wherein said measuring step utilizes a sonar measurement device.

12. The method of claim 9, wherein said measuring step utilizes a radar measurement device.

13. The method of claim 9, wherein said measuring step utilizes two digital photographs of said object taken from two locations of a known distance from each other.

14. A method for photographic measurement, comprising the steps of:
creating a digital photo image of a target area using a digital photographic camera;
projecting an image onto said target area;
using software capable of determining one or more angles at which said camera is placed relative to said target area using said image; and
processing said image to extrapolate the dimensions of an object in said image using said angles.

15. The method of claim 14, wherein said image is two or more laser beams of a known distance apart.

16. An apparatus for photographic measurement comprising:
a camera, for creating a photograph of a target;
a scaling instrument, for use in providing a basis upon which measurements of objects within said photograph may be derived; and
software, capable of analyzation of said photograph, such that said basis may be derived.

17. The apparatus of claim 16, wherein said scaling instrument is an object of known dimensions disposed within said photograph.

18. The apparatus of claim 16, wherein said scaling instrument is a projection of known dimensions projected within said photograph.

19. The apparatus of claim 16, wherein said scaling instrument includes at least two photographs of said target, each taken from a known separation distance.

20. The apparatus of claim 16, wherein said scaling instrument is at least two laser beams projected within said photograph of which the distance of separation between said laser beams is known.

21. The apparatus of claim 16, wherein said scaling instrument includes the known distance from said camera to said target, such that trigonometry may be used to derive measurements within said photograph.

22. The apparatus of claim 21, wherein said known distance is derived using an sonar measurement device.

23. The apparatus of claim 21, wherein said known distance is derived using an acoustic measurement device.

24. The apparatus of claim 21, wherein said known distance is derived using a radar beam measurement device.

25. The apparatus of claim 21, wherein said known distance is derived using a stereoscopic camera.
